(19) United States
(12) Patent Application Publication
(10) Pub. No.: US 2016/0027289 A1
(43) Pub. Date: Jan. 28, 2016

(54) COMMUNICATION SYSTEM

(71) Applicant: Gregory W. Hargis, Elgin, IL (US)

(72) Inventor: Gregory W. Hargis, Elgin, IL (US)

(21) Appl. No.: 14/338,727

(22) Filed: Jul. 23, 2014

(51) Int. Cl. G08B 25/01

(52) U.S. Cl. CPC G08B 25/016

(57) ABSTRACT

A communication system permits communication between hospital staff and a patient, while allowing for communication between at least two staff members and the patient, and permitting efficient determination of the type and urgency of the service needed by the patient.

This invention relates to a communication system and more particularly to a communication system, which may be used for communication by patients between nurses, doctors, and other hospital personnel; as well as between various members of the hospital personnel, medical personnel, or other personnel necessary for patient care.

### BACKGROUND OF THE INVENTION

When a person is a patient in the hospital, it is very critical that the patient be able to efficiently communicate essential patient needs to the hospital staff quickly and efficiently. Likewise, it is important for hospital personnel to quickly and efficiently determine the nature of the communication. The hospital personnel can then plan the response thereto appropriately.

The staff may include a nurse, a technician, a doctor, an assistant, or other personnel employed by the hospital to provide patient services. The communication must be quick, easily analyzed, and permit a response thereto. The response must be in line with the service needed by the patient. To that end, such communication must indicate situation of that patient as soon as possible.

Currently, such communication devices require a response from the nurse or other personnel directly to the patient, which requires actual verbal contact with the patient. The time to establish such a verbal contact or other contact can be critical in determining what the patient needs and how fast it must be delivered. If a manner or device can be developed to simplify this contacting process between the patient and the appropriate personnel, great advantages are obtained for both the patient and the hospital personnel. Response times are greatly reduced with such a system. However, hospitals lack such an efficiently designed system.

Other personnel in the hospital play an important role for a patient, as well as assist medical personnel. Typical of these people are clergy, social workers, dieticians and food service providers, maintenance people, and cleaning people. Each of these people can play and do play an important role in the recovery of the patient. Thus, it may also be critical to the patient to be able to contact members of this group of people.

One prior art system first sends a message to the server. Then the server identifies the message and prioritizes it by level of urgency. This action can then generate one or more additional messages to the health care provider through a cooperating device. The plurality of steps delays help to the patient.

While no one communication system operates effectively in all cases (especially in a hospital), nothing has been developed to take advantage of the variety of communication modes. Sometimes a text message works. Sometimes a voice message works. Sometimes a signal works. Sometimes a different communication mode works. It is very desirable to be able adjust to a communication mode depending on the situation. Such adjustability is unavailable, especially in a hospital.

If such a communication system can be designed, patient care can improve, while at the same time, the hospital personnel, as well as other personnel, can make more efficient use of the skills required. To that end, a major improvement in the communication between a patient and a member of the hospital staff, as well as between staff members and other personnel, offers many great advantages to all parties concerned.

### SUMMARY OF THE INVENTION

Among the many objectives of this invention is the provision of a communication device, which provides communication between a patient and hospital staff.

A further objective of this invention is the provision of a communication device, which provides information regarding the type of patient support needed.

Yet a further objective of this invention is the provision of a communication device, which minimizes interference with hospital procedures.

A still further objective of this invention is the provision of a communication system, which is easily transported.

Another objective of this invention is the provision of a communication device, which is easily adjustable.

Yet another objective of this invention is the provision of a communication device, which provides communication with more than one person.

Still another objective of this invention is the provision of a communication device, which permits hospital staff to remember the patient needs service.

Also, an objective of this invention is the provision of a communication device, which permits a hospital staff member to obtain assistance.

A further objective of this invention is the provision of a communication device, which permits a hospital staff member to send appropriate help from a second staff member when the first staff member is otherwise occupied.

A still further objective of this invention is the provision of a communication device, which permits use of a variety of communication modes.

Yet a further objective of this invention is the provision of a communication device, which permits use of a voice communication mode.

Another objective of this invention is the provision of a communication device, which permits use of a visual communication mode.

Yet another objective of this invention is the provision of a communication device, which permits use of a text communication mode.

These and other objectives of the invention (which other objectives become clear by consideration of the specification, claims and drawings as a whole) are met by providing a communication system, which permits communication between hospital staff and a patient, while allowing for communication between at least two staff members and the patient, and permitting efficient determination of the type and urgency of the service needed by the patient.

### BRIEF DESCRIPTION OF THE DRAWINGS

FIG. 1 depicts a box chart of the communication system 100 of this invention and various communication advantages.

FIG. 2 depicts a box chart of the communication system 100 of this invention and various communication advantages between the patient 102 and various personnel.

FIG. 3 depicts the communication system 100 of this invention and various communication advantages between the patient 102 as an adult 104 and a doctor 108 or a nurse 106.

FIG. 4 depicts the communication system 100 of this invention and various communication advantages between the patient 102 as a child 110 and a doctor 108 or a nurse 106.

FIG. 5 depicts a patient device 120 for the communication system 100, with the patient device 120 showing a child screen 150.

FIG. 6 depicts the child screen 150 of FIG. 5 with cartoon like characters 152 thereon.

FIG. 7 depicts the child screen 150 of FIG. 5 with icons 154 thereon to provide a message to a nurse 106, such as is shown in FIG. 4.

FIG. 8 depicts the child screen 150 of FIG. 7 with a selected icon 160 along with a cancel option 162.

FIG. 9 depicts a function screen 200 for patient device 120 of communication system 100.

FIG. 10 depicts the function screen 200 of FIG. 9 with a function icon assembly 202 thereon.

FIG. 11 depicts a function screen 200 for nurse device 120 of communication system 100 with a first settings screen 204 thereon.

FIG. 12 depicts a function screen 200 for patient device 120 of communication system 100 with a second settings screen 206 thereon.

FIG. 13 depicts a function screen 200 for patient device 120 of communication system 100 with a third settings screen 220 thereon.

FIG. 14 depicts a function screen 200 for nurse device 120 of communication system 100 with a fourth settings screen 238 thereon.

FIG. 15 depicts a box chart of communication system 100 of this invention working with a nurse 106.

FIG. 16 depicts a box chart of communication system 100 of this invention working with a nurse 106 through video messaging 400.

FIG. 17 depicts a box chart of communication system 100 of this invention working with a nurse 106 through a smart device.

FIG. 18 depicts communication system 100 of this invention showing a version of the first unresponded screen 460.

FIG. 19 depicts communication system 100 of this invention showing a version of the second unresponded screen 470.

FIG. 20 depicts communication system 100 of this invention showing a version of video messaging 400.

FIG. 21 depicts communication system 100 of this invention using emergency button 240.

FIG. 22 depicts communication system 100 of this invention interacting with the station for nurses 118.

FIG. 23 depicts communication system 100 of this invention showing written communication from the nurse 106 of FIG. 3.

FIG. 24 depicts communication system 100 of this invention showing the nurse 106 of FIG. 3 reviewing duties.

Throughout the figures of the drawings, where the same part appears in more than one figure of the drawings, the same number is applied thereto.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, may be used with respect to the drawings. These and similar to directional terms are not to be construed to limit the scope of the invention in any manner. The words attach, connect, couple, and similar terms with their inflectional morphemes do not necessarily denote direct or intermediate connections, but may also include connections through mediate elements or devices.

The communication system of this invention creates a better exchange of information between a patient and a nurse or nurses, as well as nurse to nurse communication. It is also applies to other hospital personnel. A primary focus for this communication system can be its use in hospitals for children. Designing a fun, a personal, an efficient and an easy approach to patient care is of the utmost importance in designing the communication system.

The communication system has many distinct characteristics that make it both different and unique as well as a better approach to the protocol system in place in most hospitals. It can be useable in most existing protocol systems, but can also create new and better possibilities in the workflow for a nurse.

The communication system creates a very unique cooperation system between patients and nurses, as well as communication for nurse to nurse or other hospital personnel. Included therein are multiple ways for a patient to communicate to a nurse or other hospital personnel. This communication system includes; but is not limited to; video chat, audio only chat, simple one touch buttons, a written message, speak to text, a simple mode (using one button), an emergency button and video messaging.

Also in the communication system is a protocol in which pressing of the emergency button causes all nurses in the unit to be notified. Additionally, the head nurse can be paired with another nurse or technician or aide for easy communication. All can both receive messages from the patient and respond thereto. All messages from patients and nurses can be displayed and interacted with at the floor station for the nurses.

The patient request can trigger a light of any color outside the room of the patient to give a visual indication to the nurses as to the request of the patient without looking at their phone to see the particular need of the patient. A certain desired color can indicate how severe the problem might be. The communication system provides a smart watch capability or cooperation with other peripherals, as well as provides an audio feedback when a user or patient presses a button, reads a message that is received back to the patient or nurse, or works for other situations. This communication system sends or receives messages on all devices, including the patient device.

Any communication device which is capable of communicating with another device and receiving return communications can be used in this communication system. Thus, a laptop computer, a desktop computer, a tablet, a smart watch, a smart phone, or other devices may be used. It is anticipated that a nurse working the floor will use a tablet or smart watch. It is anticipated that a doctor will prefer to use a tablet. The station on the hospital floor used by the nurses will probably have a desktop computer or a server or multiples of these devices. However, these various devices are described as a patient communication device with the hospital patient being able to communicate with at least one hospital communication device as can be used by any of the parties or hospital staff hereto. Each party will determine what device best suits the particular purpose.

The communication system will have a different set up depending on the need of the patient, the floor the patient is on, or the preference of the patient. This communication system can even have a peripheral for the patient to send an emergency message when the patient is away from the tablet in the room or with the patient away from the room such as on a walk, with the tablet in close proximity. For example, the patient device can be a tablet, a smart phone or a smart watch.

The tablet may be attached to a flexible arm mounted on the hospital bed. Thus, the tablet can be moved or positioned to suit the patient. The flexible arm is attachable to a bed, a wall, a portable surface, or other suitable surface. Two non-limiting examples of a portable surface are an intravenous pole or a wheel chair. Such a structure permits the patient to have a better control of the patient device.

Each nurse can quickly and easily choose the appropriately assigned patients, while also having the ability to communicate with any of the nurses or station for the nurses on their respective units. This communication system can be completely mobile, both for the patient and nurses and nurse station.

Children will like this communication system. For children specifically, the communication system can include fun entertainment such as animation and games for patients, while still providing ease of use for communication with hospital staff. An example would be a character talking to the patient saying things such as, “You are in pain?! I will let your nurse know right away.” Then a message will be sent to a nurse that the patient is in pain. The communication system can provide a graphical element, such as a drawing of a person or animal, for patients to press when they are in pain, and a message is then sent to the nurses accordingly.

The communication system can provide the nurses with the ability to contact doctors or other units within the hospital without the use of a cellular phone system. The communication system can be set up hospital wide for communication purposes. It can even allow doctors to communicate with patients directly in any of the communication forms.

Furthermore, this system creates a reminders page in which messages are rendered in order of time from both patients and nurses. Nurses can also create their own reminders that are then populated in the reminders page. Therefore the system creates a way to display not only patient requests, but also nurse communications as well as nurse notes.

The communication system creates a way for nurses to write notes and vital sign notes about each patient on their own page. Those notes will be available on all nurse devices until the patient is checked out of that room or hospital. An unresponded or unanswered setting assures that a patient request receives a response in a timely manner. Requests or communications can then remind a nurse if left unanswered. A check-off, even a manual check-off, for the system permits the nurse to check off when a request has been completed.

The communication system may also include a tracking application or device, which has the ability to track a nurse or nurses, or a patient or patients using iBeacons or similar devices. For example, it can automatically send messages when a nurse enters a room or specific area. Additionally, it can also provide a map of the floor that easily tracks the last known location of either nurses or patients.

Exercise information can come to a patient to do exercises from an exercise application in the communication system for instructing the patient on an exercise procedure while in the bed or room. This is another fun, animated way that the system communicates with the patient. The communication system uses already established tablets such as an iPad mini. The very nature allows patients the ability to use other applications or apps such as games, books, video, the internet and the like.

Mobility is easily handled. The patient device for communication system can be attached to a surface; or a mobile device, such as an intravenous (IV) pole, for easy mobility throughout the room and hospital. It may also be removed completely from the IV pole or other support for even easier mobility, while still maintaining communication with the nurses or other hospital personnel.

Even further, the communication system can also provide a way for a patient to order food. The patient can then send a message to the food service at the request of the patient. There will also be settings that are accessible to the nurse as to the specific diet of the patient, and which in turn, will display the proper foods allowed for that patient. Such coordination provides the proper diet for the patient in an appropriate series of checks and balances.

There will be a settings page for all devices whether used by a patient, a nurse, a doctor, other staff or the station for nurses. This set up shows how nurses can easily communicate with each other and quickly back to patients using multiple ways such as text button, shortcut buttons, video chat button, video message button, or other function. A “get that” button idea can send a message to other personnel such as an assistant as set up in the settings page. A nurse may also easily use the settings page to set patient room assignments for the nursing assigned to a patient for a particular work shift.

This will allow settings such as icon settings, floor or unit settings, nurse assistant, room assignments, user log in and names as well as updates. Both patient and nurses are able to see a log of the communications made. Patients and nurses can see what each other has done, said or sent for a set amount of time. Both the name and room number of patient are available with all communications being HIPPA compliant.

An update procedure is important. A patient may change rooms or medical status. The sooner the nurse or another has knowledge of such a change, the better it will be for the patient. Patient care; including but not limited to items such as status, drug regimen, diet change or treatment procedure can be more quickly adjusted.

Icon settings or button uses are flexible. The icon on the screen provides an indication of the button or where to touch the screen of the device for the patient or hospital staff member to achieve the desired result

Nurses will have a unique log in system in conjunction with the system for each hospital or a unique log in system. The communication system has a simple mode, which provides the patient with limited options, and simple or ease of use. A patient has the ability to choose this mode. Patients are able to send multiple requests or messages, even if the first request or message has yet to receive a response. If a video chat is enacted by the patient, and the nurse who is set up to answer the call does not answer, the device will then try to establish another connection with another nurse or nurse station.

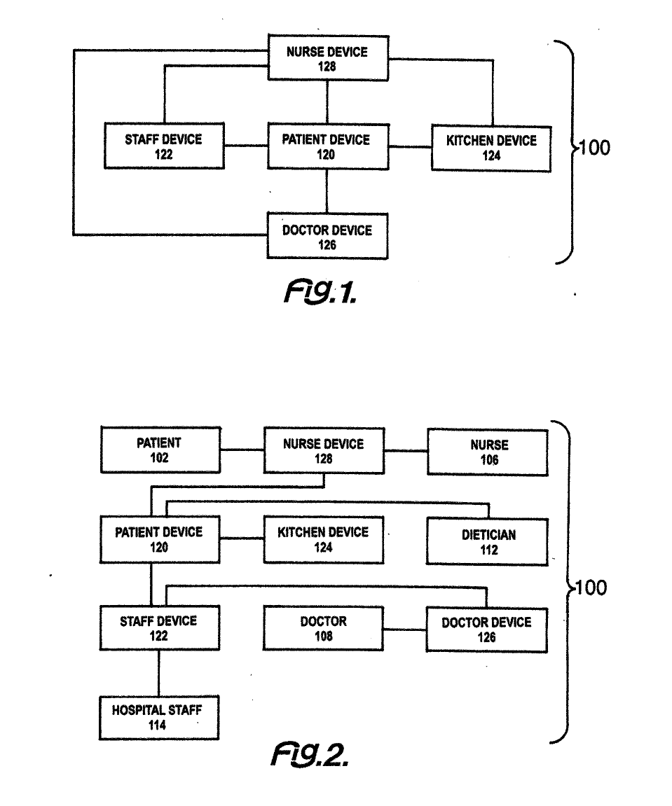

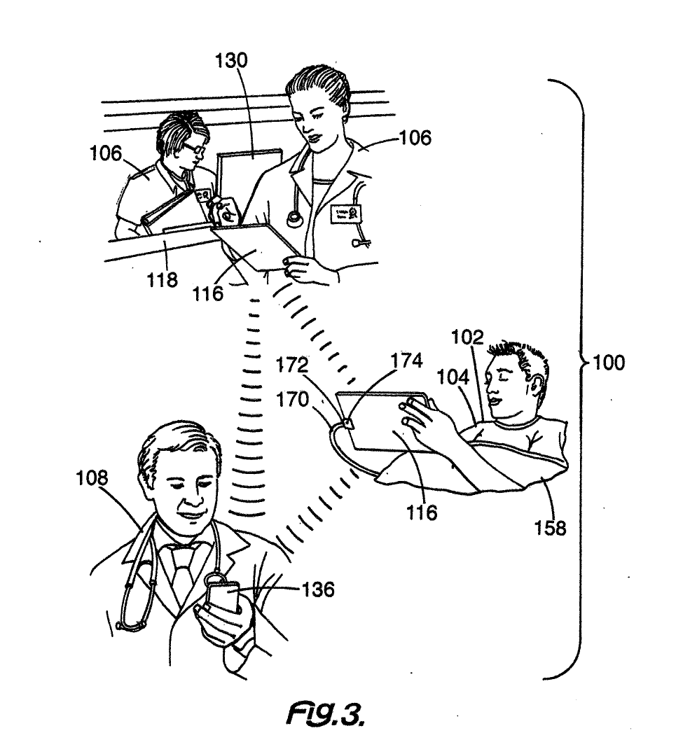

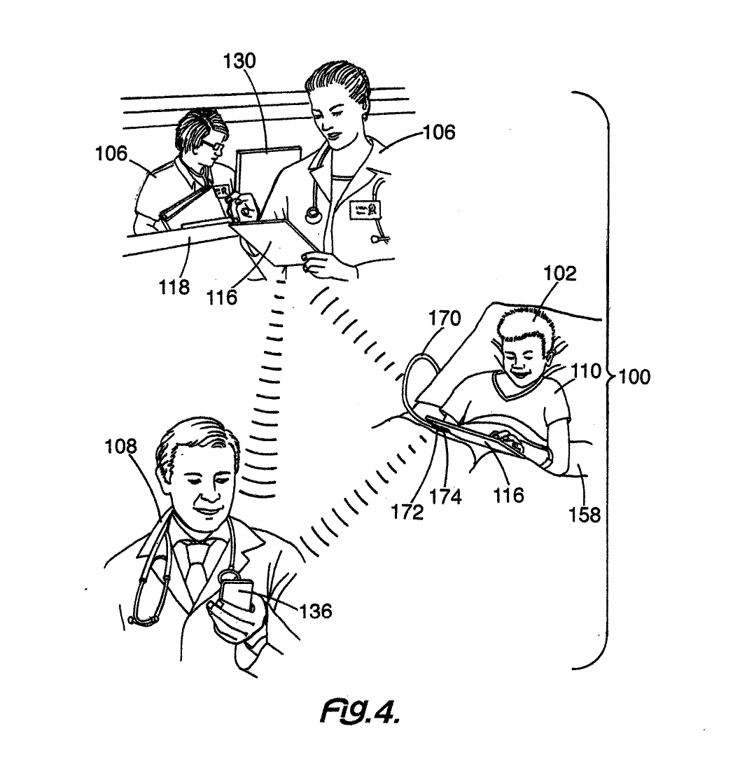

Now considering FIG. 1, FIG. 2, and FIG. 3, communication system 100 includes a patient device 120, a staff device 122, a kitchen device 124, a doctor device 126, and a nurse device 128. Each of those devices form part of a device system, which provides two-way communication between each or any pair or multiples thereof, while at the same time providing access to at least one other device as desired. Thus patient 102 activates patient device 120 to communicate with nurse 106 through nurse device 128. In a similar fashion, the patient 102 may communicate with other hospital staff 114 through staff device 122, doctor 108 through doctor device 126, dietician 112 through kitchen device 124, or any other desired person.

Patient device 120; or hospital communication device such as a staff device 122, a kitchen device 124, a doctor device 126, or a nurse device 128 may be a smart phone, a tablet, a laptop, a desk top computer or any other suitable, compatible device. Each device must be able to communicate both ways with any other device. In this fashion, the appropriate person may respond to the needs of the patient efficiently. It is possible for the staff to know what the needs are before entering the room of the patient. Such flexible, two-way, usable communication devices permit this efficiency.

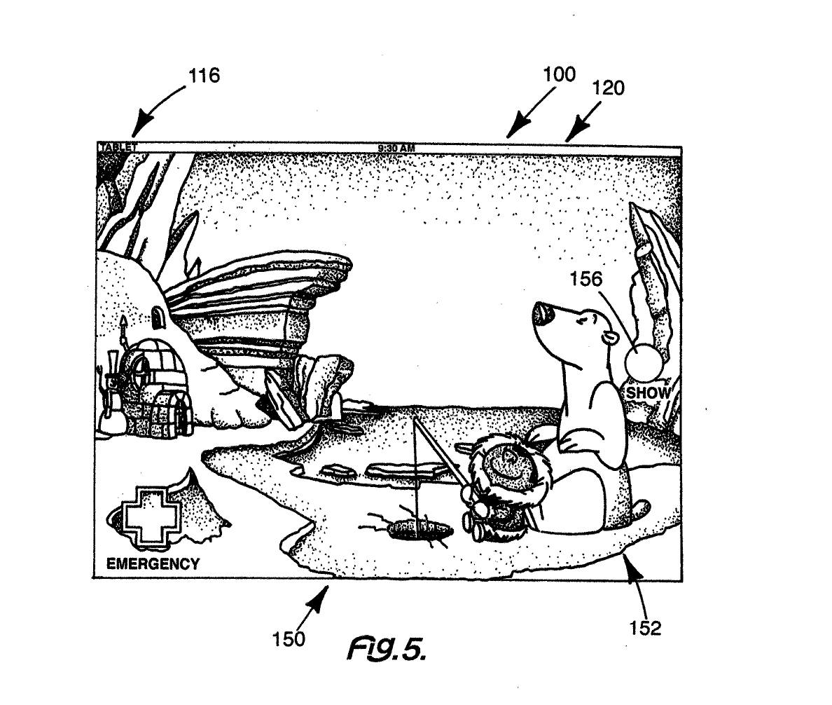

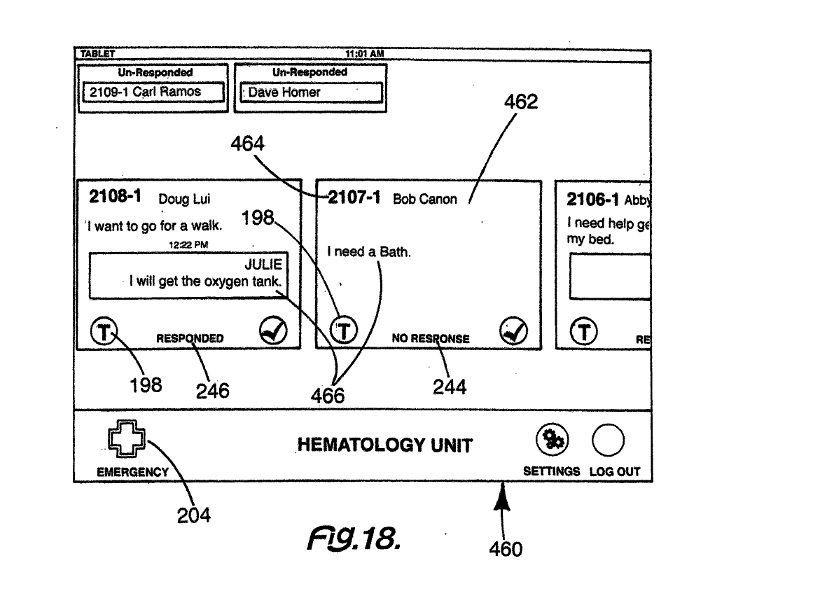

Adding FIG. 3 to the consideration, an adult 104 is using a tablet 116 to communicate with a nurse 106 on a desktop computer 130 or a doctor 108 with a smart phone 136. A tablet 116, a smart watch 396 (FIG. 17), smart phone 136 displaying a message 394 (FIG. 17), or other appropriate or smart device may also be used. The communication can be directed and controlled by the adult 104. The adult 104 may also use other acceptable devices from bed 158. The desired person can see the communication and respond appropriately if required. Additionally, the child 110 in bed 158 (FIG. 4) has access to the tablet 116.

Considering FIG. 3 and FIG. 4 together, flexible arm 170 permits the tablet 116 to be accessible to the child 110. At one end of flexible arm 170 (FIG. 4) is a support attachment 172, permitting the flexible arm 170 to be secured as desired. Support attachment 172 can be mounted on a bed, a wall, an intravenous pole or other device. At the other end of flexible arm 170 is a tablet attachment 174 to receive tablet 116. With the flexible arm 170, the tablet 116 may be easily used by the child 110, or another patient, as desired. Tablet 116 may also be removed from the flexible arm 170 and taken with the patient as desired. For example, the tablet attachment 174 can be a magnet, a clip, a holder or other device to hold the tablet 116 in place on the flexible arm 170.

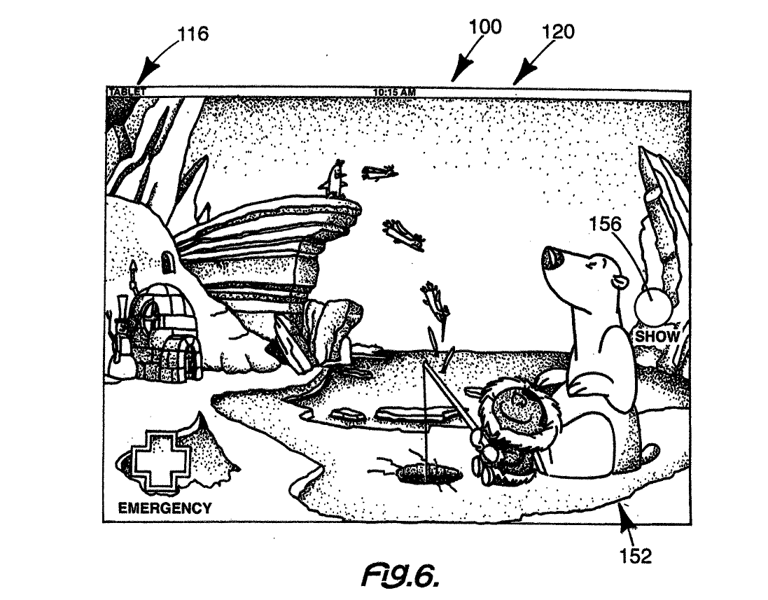

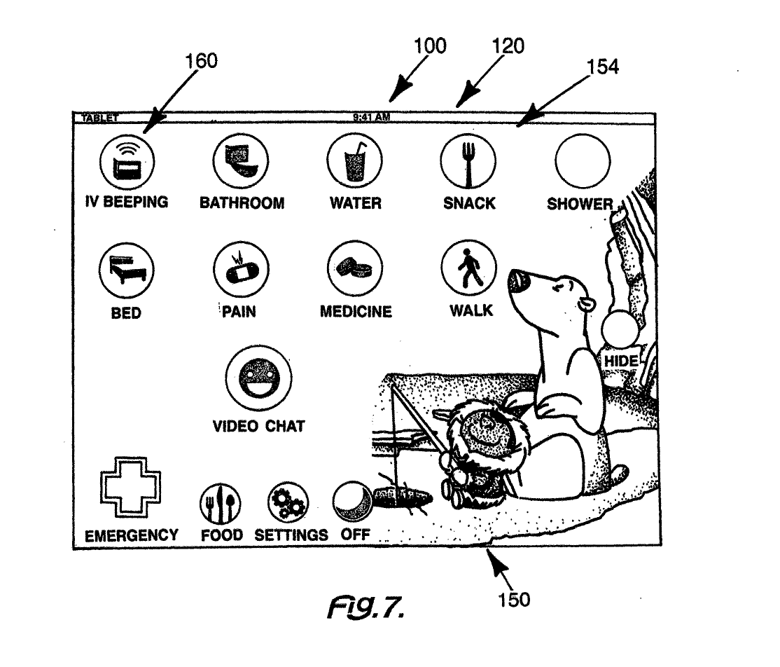

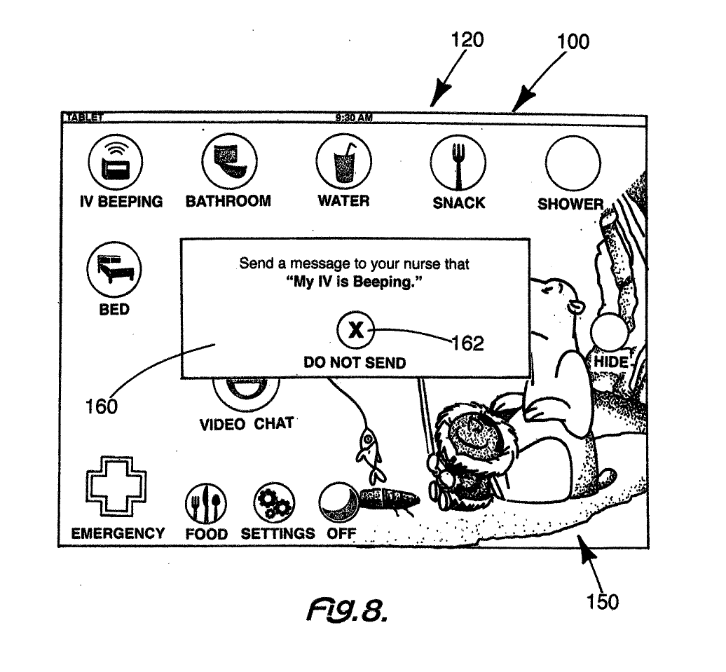

Adding FIG. 5, FIG. 6, FIG. 7 and FIG. 8 to the consideration, the use of communication system 100 by a child 110 of FIG. 4 becomes very feasible. Referring back, FIG. 4 is very similar to FIG. 3, except with the change that the adult 104 is replaced by a child 110. From the patient device 120 (FIG. 1), the child screen 150 has representations on the tablet 116 depicting cartoon like characters 152. Icons 154 are displayed by activating show button 156. Then the selected icon 160 can be displayed for a period of time. If cancel option 162 is pressed before that period of time expires, the notification of the nurse 106 (FIG. 4) or other staff will be canceled. Icons 154 are indicated by words and symbols to assist a child 110 (FIG. 4) in the determination of services required.

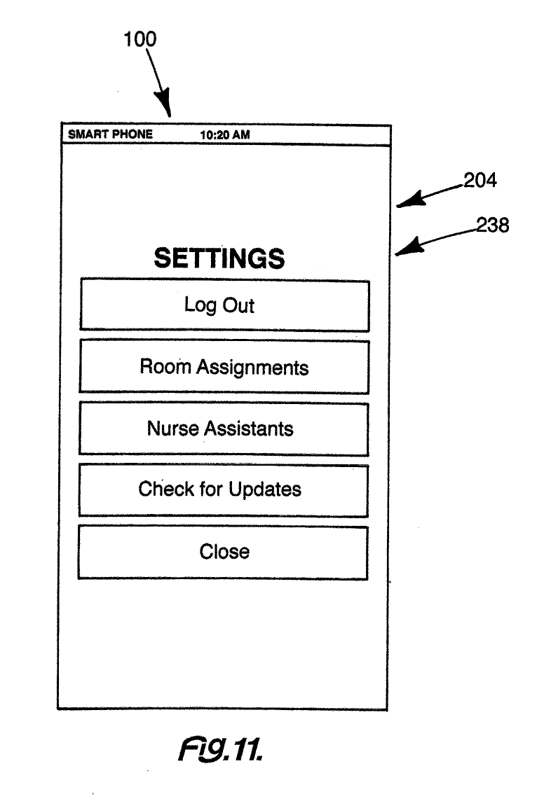

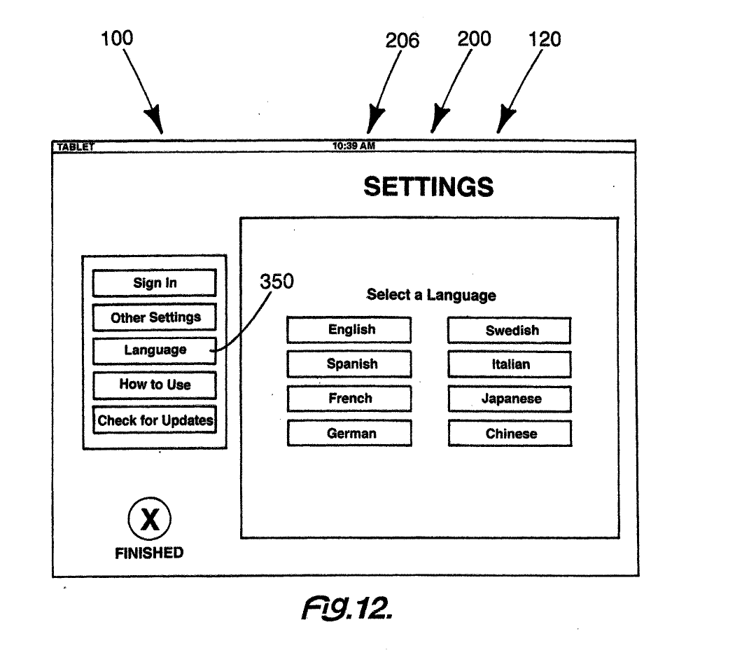

The nurse 106 of FIG. 3 and FIG. 4 will first need to sign into the device using assigned log in or sign in credentials as shown in FIG. 11. Each hospital may have different a different way to sign in 214 to the computer system and hence communication system 100. Once logged in, the nurse 106 will first choose which the unit to which the assignment is made in a manner similar to that of FIG. 13, where the patient setting also chooses to which unit it is assigned. Then the nurse 106 will select which rooms and patients to which the assignment applies as shown in FIG. 11. Doing this communicates to the server 134 (FIG. l5) where the messages from the patients will be sent. Next each nurse 106 will choose the associate or associates for the work shift, as shown in FIG. 11. Most nurse protocols for a hospital have two or three nurses or techs responsible for each room and often have two or more personnel work together.

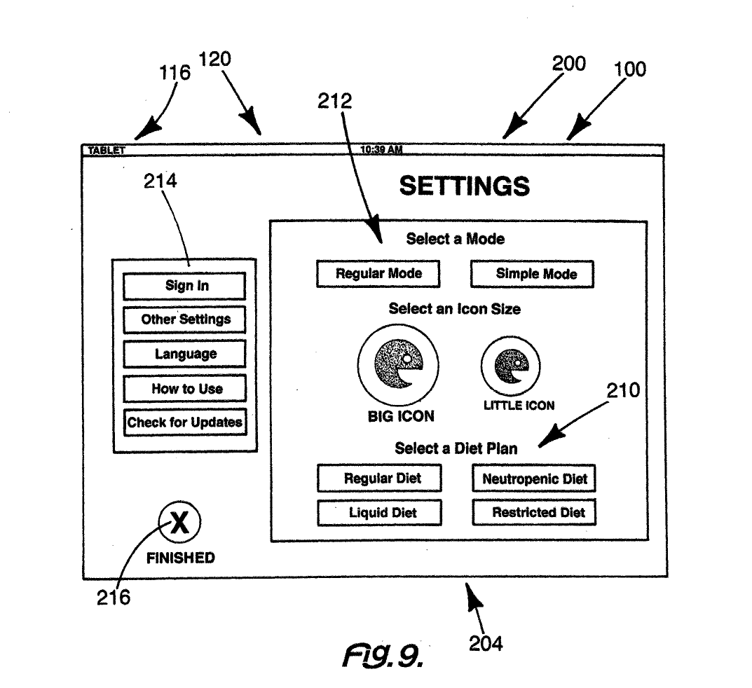

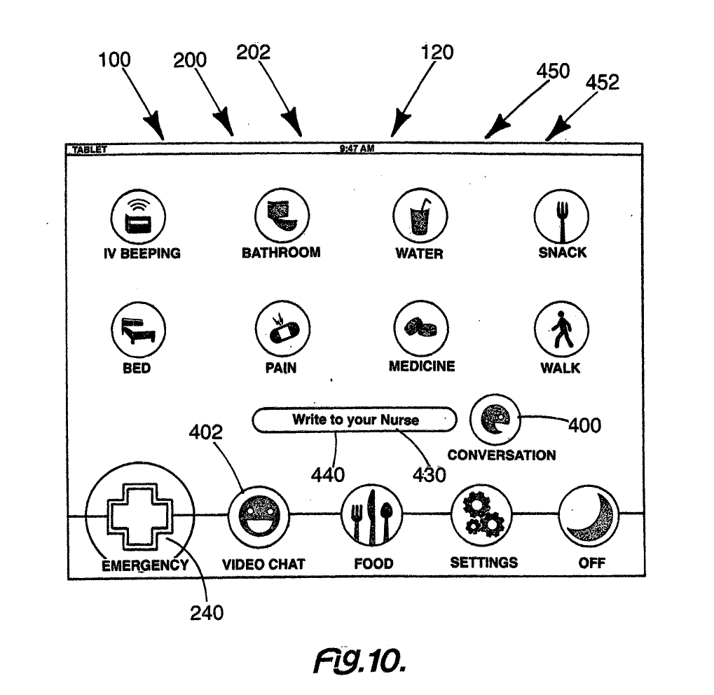

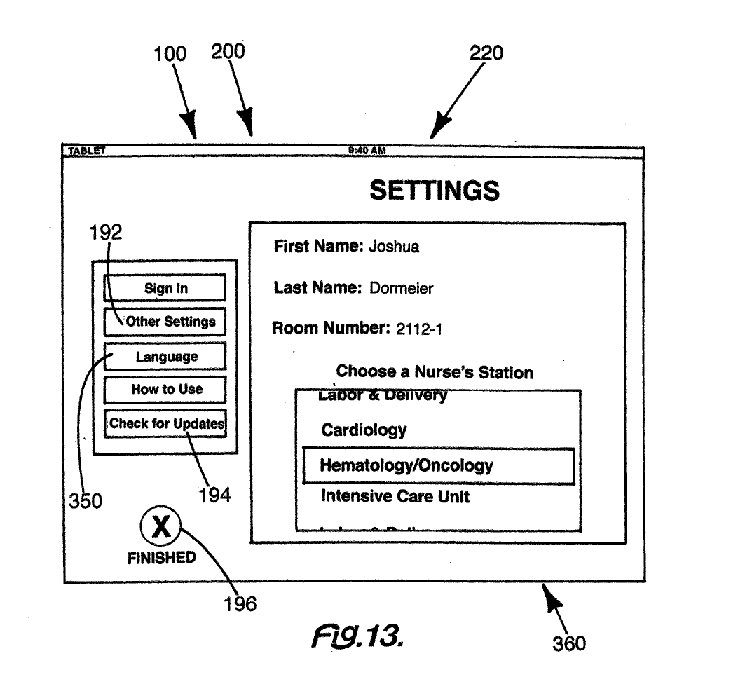

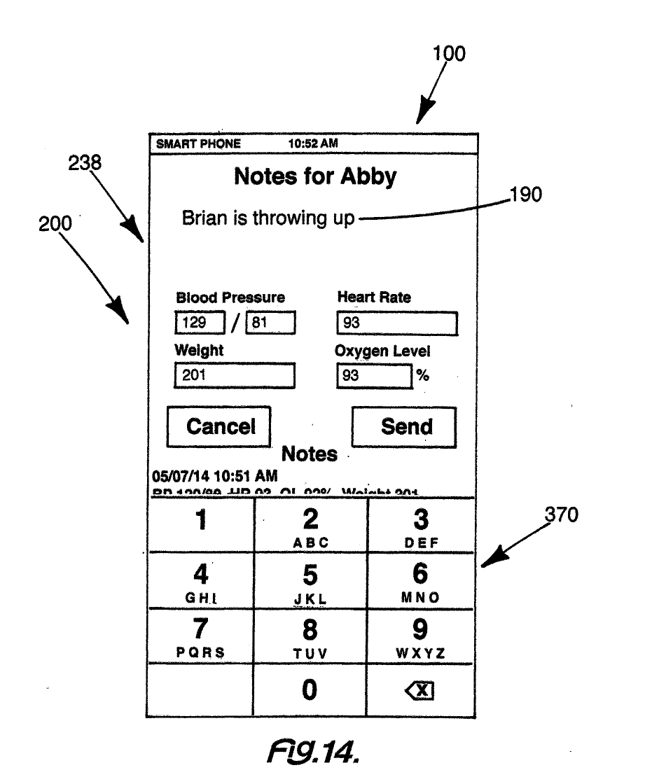

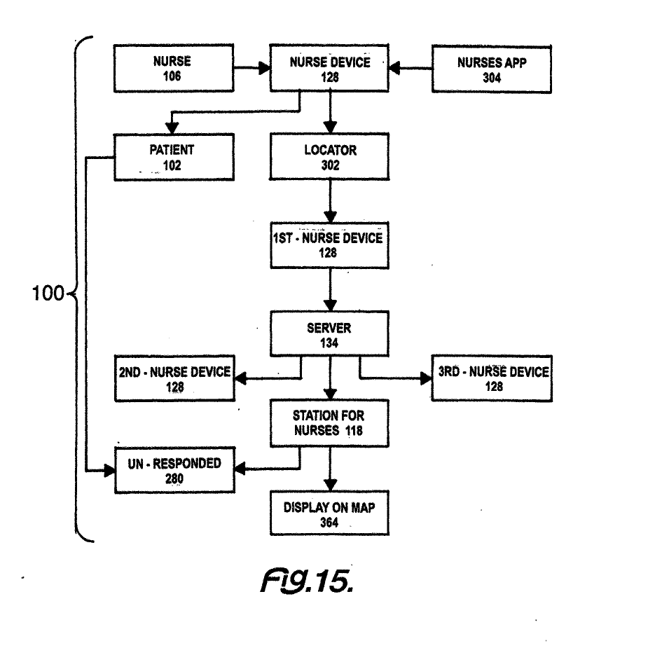

Further considering FIG. 9, FIG. 10, FIG. 11, FIG. 12, FIG. 13, and FIG. 14, the communication system 100 shows an adult version of symbols. In FIG. 9, the function screen 200 is shown on tablet 116 of FIG. 3 and FIG. 4 and can be used by an adult 104 (FIG. 3) or child 110 (FIG. 4). The function icon assembly 202 (FIG. 10) permits an appropriate adjustment of the function screen 200. The first settings screen 204 permits icon selection and various other adjustments of the screen. Diet selections 210, mode selections 212 and up selections 214 are just a few of the possible uses. Various other settings can be depicted on a settings page and cover first settings screen 204 as well as other settings screens.

Many other options are also available. Diet selections 210 include regular diet, neutropenic diet, liquid diet, and restricted diet; as well as other diet selections. Mode selection 212 permits regular mode or simple mode, as well as other modes, as well as picking icon size. Set up selections 214 permit sign in, other settings, language, how to use instructions and updates. Once the setup is finished, the finished key 216 moves the function screen 200 into the active state.

In FIG. 10 on the patient device 120, second settings screen 202 displays various adult style icons. These icons can tell the nurse 106 (FIG. 2) the desires of the adult 104. The write to your nurse function activates a keyboard to send a written message 430. Conversations permit a patient to chat with nurse 106 about various functions; such as an intravenous monitor beeping or desires such, bathroom, water, snacks, pain, medicine, law, and food. There are also options to change the settings, turn off the screen or indicate an emergency by using emergency button 240 in a very quick fashion, as well as many other options.

More particularly, FIG. 10 shows video messaging 400 with a button for video chat 402. Then there is a button for conversation 400, which can provide a text dialog history from the patient and nurses. Also there may be set of other one button touches. A patient 102 may also reach a nurse 106 (FIG. 1) by typing or using speech to text 440. Other simple touch buttons 450 are available on this simple touch screen 452. A typical program for speech to text 440 is Dragon Naturally Speaking, available from Nuance Communications, Inc., Worldwide Headquarters, 1 Wayside Road, Burlington, Mass. 01803.

In FIG. 11, fourth settings screen 238 permits the nurse 106 of FIG. 3 to check various items as required. Nurse 106 of FIG. 3 and FIG. 4 can also check appropriate information about the patient. Thus room assignments, updates, closing the system or logging out is permitted, as well as other desired settings.

With FIG. 12, communication system 100 provides language settings 350, which permit the patient to select an acceptable language to receive and send information. Language settings 350 are adjustable and permit language selection. Patient device 120 can access this system, which shows the adult screen 200, with second settings screen 206. Also available are sign in, other settings, language, use instructions or updates to assist the patient.

FIG. 13 shows that function screen 200 for FIG. 12 can be set up to communicate with any suitable device at the station for nurses 118 of FIG. 3 and FIG. 4. A third settings screen 220 is displayed. Then the appropriate screen can be set up. For example, registration 360 can set the hospital unit, such as hematology. A phone keyboard 370 can also be used by nurse 106 to enter information for a patient.

Once all of the settings are completed, the nurse 106 is taken to the reminders page of FIG. 24, which is the core of the communication system 100. Every time a new message comes in from a patient 102, nurse 106 or station for nurses 118, it will appear here. There may be an audible notification as well as a vibration for each new message. If the hospital so chooses, a notification on a smart watch can also be sent.

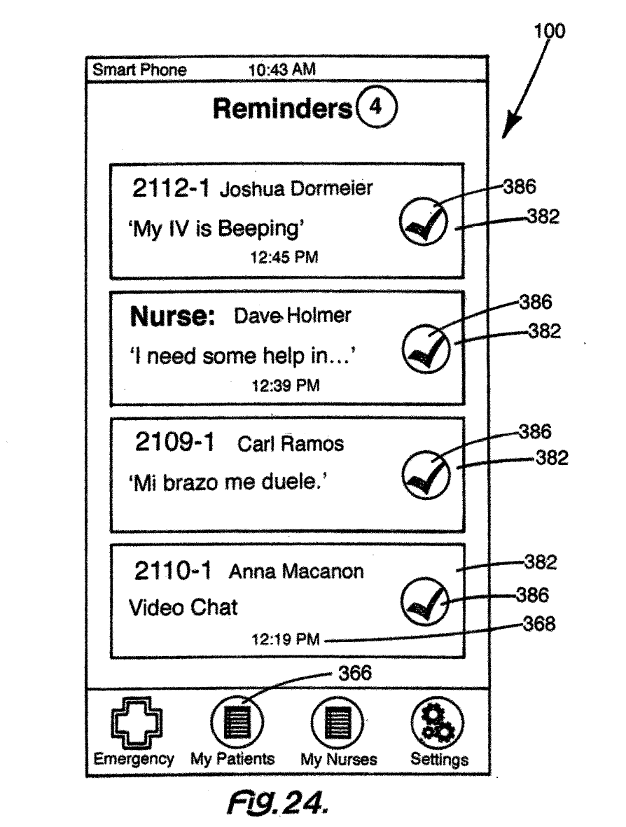

The nurse 106 may then click on the message and will be taken to the individual page for that patient with a fourth settings page as shown in FIG. 23, which is the page that shows up when the nurse clicks on the message. FIG. 14 is shown when the nurse clicks on the “Notes” button shown on FIG. 23. There the nurse 106 can use the shortcut buttons to quickly reply, write a custom message, use video chat or send a video message. A video message is a recording of the nurse that provides a personal message for the patient 102 to watch. It is a quick and personal way of communicating one-way.

The nurse 106 can use many nurse settings also has the ability to get other settings. FIG. 23 can house a get “this button” and will send a message to other personnel with whom nurse 106 is connected, to ask that person to take care of that specific request. Nurse 106 usually has a set of assigned coworkers to assist on each shift. The nurse settings can also set up.

There is also a history view or a check for updates button 194 (FIG. 13), where the nurse 106 can review the communication for a desired time period, the time period being determined by each hospital. The checkmark button 386 (FIG. 24) is activated once a particular task has been completed and no longer needs to be on done. This will delete it from the reminders page on FIG. 24.

A translate button or language button 198 is used when a patient 102 sends a message via a shortcut button that is not in English, in order to automatically translate the message into English. If the message is a custom message, hitting the translate button 198 will then pop up a website that will automatically translate the message for the nurse 106.

The reminders page, FIG. 24, can be color coded for easy viewing. For example, a white reminder can indicate that the nurse 106 has already viewed that message but has not acted upon it yet. Further a dark green reminder can indicate that the nurse 106 has not viewed that message yet. A red reminder can indicate to the nurse 106 that the message is from another nurse 106 and has yet to be viewed. A pink reminder can indicate to the nurse that the message is from a nurse 106 that has been viewed, but not acted upon; by, for example, going to the room of the messaging patient 102 and fulfilling the request. The nurse 106 can then press the checkmark button 386, which will then delete the message from the reminders page of FIG. 24.

If the hospital so chooses, can also be sent a notification can also be sent to a smart watch 396. The nurse 106 will then click on the message and will be taken to that person's individual page FIG. 23. There the nurse 106 can use the shortcut buttons (FIG. 10) to quickly reply, write a custom message, video chat or send a video message.

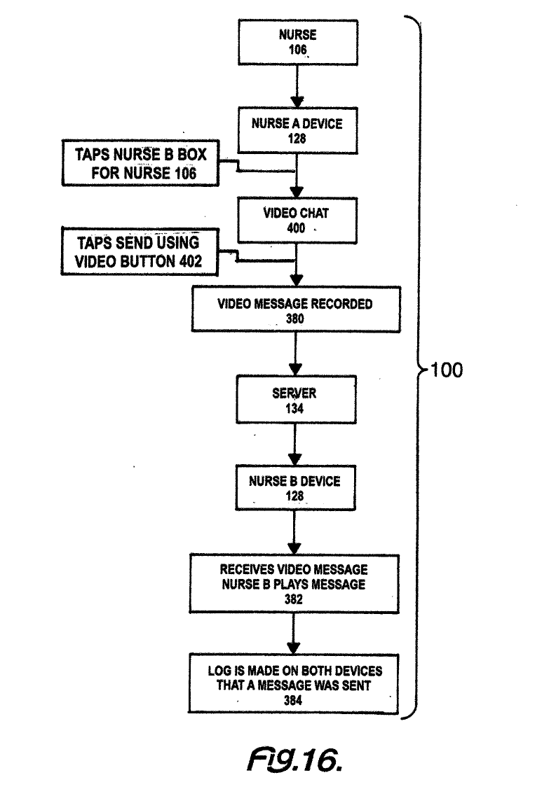

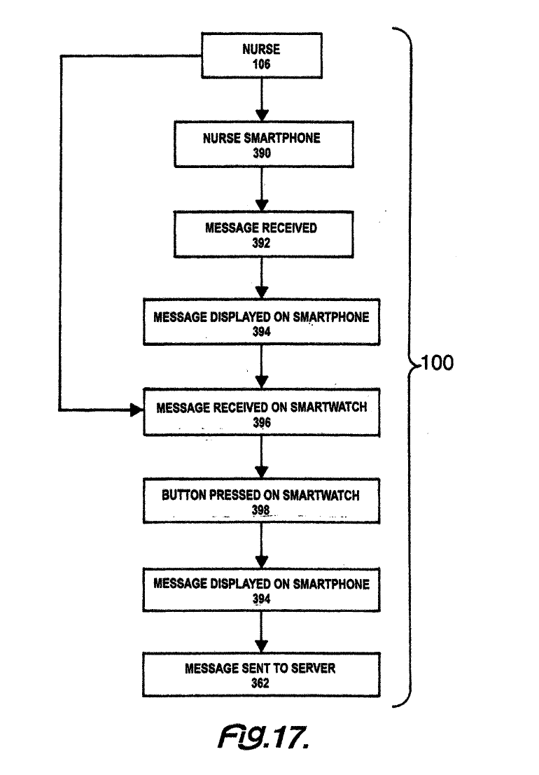

FIG. 15, FIG. 16, and FIG. 17 show the additional flexibility of communication system 100. Nurse device 128 can communicate with a locater 302, such as an i-Beacon and keep the station for nurses 118 informed of locations of a patient 102 or a nurse 106 through the registration screen 360 (FIG. 13) or nurses app 304. Apple Inc. having an address of 1 Infinite Loop, Cupertino, Calif. 95014, claims a trademark interest in the term i-Beacon.

Registration screen 360 (FIG. 13) communicates with server 134 (FIG. 15) as well as the station for nurses 118, and the location display 364, as well as any other nurse device 128, again showing the ease of communication between patients and nurses and other staff. Such action permits a focus on the overall picture of what is happening on the floor. Particularly unique to the patient 102 is how all communication from a patient is copied to any appropriate device at the station for nurses 118. As well as when a patient 102 uses the emergency button 240, the patient device 120 may then call the station for nurses 118 automatically after sending a message to all staff.

Use of video messages is one aspect shown in FIG. 16. Nurse 106 using nurse device 128 and the video chat function 402 thereof records a video message 380, which message is sent to the server 134, to another nurse device 128 or any other desired device. A second nurse 106 may play the message, and the message is logged 384 on any device connected thereto, such as another nurse device 128 The my nurses page 386 is similar to the my patients page 366, which shows all the nurses 106 and station for nurses 118 in that unit. This is a simple way for nurses 106 to communicate to the station for nurses 118 and other nurses. It shows all the nurses, not just the nurse assistants.

Use of other messages is shown in FIG. 17. Nurse 106 uses smart phone 136 for message received 392, which results in a smart display 394. The first smart display 394 goes to the smart watch message 396 in this situation. A second smart display or smart watch button 398 displays message 394 occurs followed by support from server 134 (FIG. 15) with message sent to server 362. Other personnel besides nurses 106 can use this material or equipment. The emergency button 240 (FIG. 8) will first pop up a screen asking for which room is the emergency. Once sent, a message is then sent to all of the nursing staff in that particular unit.

Communication system 100 offers at least seven different ways a patient can communicate with a nurse or other hospital personnel. The patient 102 can choose which one or more ways are the most comfortable use. This gives the patient 102 choices that most other systems do not give. Those choices include, but are not in him limited to, video messaging 400, audio only chat 410, a set of one button touches 450, written message 430, speak to send a text 440, simple touch buttons 450 and an emergency button 240.

With the video messaging 400, a patient 102 can press a video button 402 to start a video conversation with a nurse or other hospital personnel. The term nurse 106 may refer to a registered nurse (RN), a tech or technical assistant, a nurse's aide, or the nurse's station; or other coworker. Also other hospital personnel can also be contacted. The term patient 102 can also refer to family member or friend who is with the patient 102 in the designated hospital room. Which connection the system makes will depend on the protocol set in place by the particular hospital and availability of nursing help responsible for that patient.

With audio only chat 410, while similar to the video messaging 400, using audio only chat 410 allows the patient 102 to not be seen by the nurse 106, and the nurse 106 may choose to allow the video stream to be shared or not. This can create a two-way audio only or one-way patient audio, and one-way patient video.

A set of one button touches 450 are predefined buttons determined by the hospital. This set of one button touches 450 can and will most likely be changed depending on what floor or unit in which they are installed. For example, a Labor and Delivery floor will have different needs, and therefor different buttons than an oncology floor. A patient 102 can simply press the desired button from set of one button touches 450, which will send that message to the nurse 106.

With the series of one button touches 450, each of which sends a message to a nurse 106, may also be a timer function 422 that delays the message for a desired amount of time, such as five seconds. This gives the patient 102 the ability to use the cancel button 164 and stop the pressed button, so that the message will not go out. This feature allows for a mistakenly pressed button to be cancelled.

After a patient 102 presses one of the set of one button touches 450, a message will appear giving the patient 102 confirmation of the button pressed as well as a chance to cancel the button. There can be any amount of buttons in the set as deemed necessary by the hospital administration. The pressed button can be identified by an icon. The icon will not only be descriptive of the message sent, but the pressed button will be able to be set to small or large type depending on the needs of that particular patient 102.

The written message 430 is also an option for the patient 102 to write a message to the nurse 106 using an on-screen keyboard. This allows the patient 102 to write a message to the nurse, if that one of the set of one button touches 450 does not fit the needs of that patient. This allows that patient to write to the nurse 106 a particular message without needing to do a video or audio chat.

The speak to send a text 440 works along the same lines as written message 430, this function gives the patient 102 the option to write a message to the nurse by speaking into the device rather than typing on the onscreen keyboard.

The simple touch button 450 operates, if a particular patient desires an even simpler way of communicating to the nursing staff. The simple touch button 450 will have an option of having a simple screen 452 with two or three buttons. Some other buttons 454 maybe hidden on screen and accessed only by the nurse 106. The patient 102 will simply press the large icon 224, taking up most of the touchscreen display 226. Such a touch activates either the video messaging 400 or audio only chat 410. This matter can be predetermined in the setup process with the patient 102 at the very beginning of the stay, with the station for nurses 118 or simply sends a message to their nurse 106 that assistance is needed without even talking if that is desired.

An emergency button 240 can be activated when a patient thinks a personal emergency is occurring. By pressing the emergency button 240, a signal is sent to all nursing staff on that floor, even if a nurse is not assigned to that room. This allows for a faster response time by the staff. Abuse of that emergency button 240 (FIG. 10) can result in adjusting or restricting the possible use of that button or any button by the patient.

Returning now to FIG. 15, FIG. 16, FIG. 17, a nurse 106 will also have an effective reminder system. When a patient 102 sends a request, it is then sent to various devices or the cloud server, such as message sent to server 362. Then the message or connection can be relayed to at least two different people. For example, it will go directly to the nurse 106 through an appropriate device responsible for that room as well to any other nurses who are assigned to that room, such as the second nurse device 128 or the third nurse device, which the nurse 106 has established for the particular shift.

Alternatively or additionally, the message will go to the appropriate device at the station for nurses 118. This allows multiple people to be aware of the request being made as well as responses. One nurse 106 can respond, with the other nurse 106 being notified what and when that response was. It will be time stamped 368 (FIG. 24) and will display accordingly on all devices.

No computer system is capable of knowing how urgent a request is because different patients will have a different sense of urgency. Yet with communication system 100 connected wirelessly to an appropriate device, nurse 106 is always informed of what is going on, even if it is as simple as getting a glass of water for a patient. An example, where this applies, involves a patient 102 pressing the drink button, when the patient 102 must not drink. This system keeps everyone informed at all times, even for the little things.

A nurse 106 will also be able to set any reminder to populate only on that desired device capable of being used with communication system 100. Any reminder will remain on that device until a nurse 106 presses the checkmark button 386, which then takes the reminder off screen. The nurse 106 is also able to keep medical or informational notes for each particular patient such as vital signs. These may or may not be sent to other nurses depending on the desire of the hospital.

This communication system also has a feature called, Un-Responded 280 (FIG. 15) that keeps a nurse 106 informed of a patient 102, whose messages have yet to receive a response. If a message goes unanswered for a predetermined amount of time, a reminder on a suitable device will activate again, thereby alerting and reminding the nurse 106 that the patient 102 is still waiting for a response.

Expanding on the location system is possible. A location based system 300 (FIG. 15) can also be in set in place. Using a product such as an iBeacon for locater 302, and putting each one a strategic location, one may keep track of where nurses and patients are. The locater 302, such as an iBeacon, can be in every room and throughout the hallways. When a nurse 106 enters a room, in the background of the mobile device, can send a message to other predetermined nurses and to the station for nurses 118. While this will not be a notification that alerts other nurses, a nurse wanting to find where another nurse is need only to look up their name in the “My Nurses” page 304 of the app. There one can find the last location of the nurse 106.

This also allows for important demographical information on the backend, such as being able to log a time when a patient 102 sends a request to log the time a nurse 106 enters the room automatically. It is also be possible to have a map of the hospital and show where patients or nurses were last detected.

A smart watch 132 or other wearable devices can be used by nurse 106. The smart-watch 132 can cooperate or be paired with a mobile device used by the nurse 106. So when a message comes in, the nurse 106 does not need to access the telephone every time a message is received. The nurse 106 rather is able to simply look at the watch 132 to see what the message is and respond accordingly. This will keep the nurse 106 from possible contamination by keeping it a hands free operation. It can also provide the nurse 106 with the ability to respond to a patient 102 or other nurse 106 using only the watch buttons, which in turn communicates with another device to send the message.

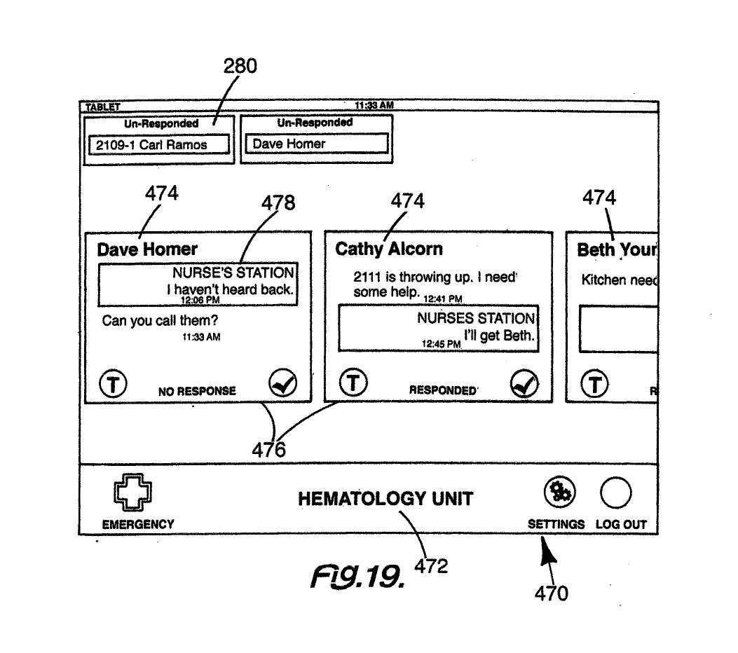

FIG. 18 depicts communication system 100 of this invention showing a version of the first unresponded screen 460. This screen 460 shows the emergency button 240, as well as a series of patients 462 with the appropriate room number 464 as well as the desired request 466. In this manner, it is possible for nurse 106 (FIG. 2) to determine a good response order.

Station for nurses 118 (FIG. 3) has an application designed to be on a full size tablet 116 such as the iPad Air. Apple Inc. having an address of 1 Infinite Loop, Cupertino, Calif. 95014, claims a trademark interest in the term iPad Air. The full size tablet 116 may be mounted on a flexible arm 170 (FIG. 4) at the station for nurses 118. It may also have a bluetooth keyboard for easy typing for the nurse 106 if the hospital so chooses. Because the full size tablet 116 is releasably mounted, it can also be easily removed from the flexible arm 170 (FIG. 4) and taken with the nurse wherever she may need to go.

Station for nurses 118 is designed to give a nurse106 so stationed an overview of everything going on in the unit as shown in FIG. 18. Each nurse is able to see every conversation between the patients and nurses. They are also able to see conversations between the station for nurses 118 and other nurses 106.

FIG. 19 depicts communication system 100 of this invention showing a version of the second unresponded screen 470. This screen 470 shows the hematology unit 472 with hematology patients 474 and hematology rooms 476. Hematology requests 478 are also pictured and again permit nurse 106 (FIG. 2) to determine the appropriate response order.

Further in FIG. 19, the station for nurses 118 (FIG. 3) is usually not able to see conversations between nurses 106, although this is possible. Having the ability for one or two nurses to have an overview of all the patients, helps insure that all the needs for a patient are being met in a timely manner. Each message that a patient 102 sends shows up on the computer page for that patient. When a new message is sent by the patient, it shows up in the appropriate page or box as well as the top of the screen in the Un-Responded box 280. This lets the nurse 106 at the station for nurses 118 know, that the nurse 106 responsible for that patient 102 (FIG. 7) has not responded to that request. After a set number of minutes, there will be a notification to the station for nurses 118 for them to take care of that request. That nurse 106 can then contact the nurse 106 responsible for that patient, or take care of the request herself.

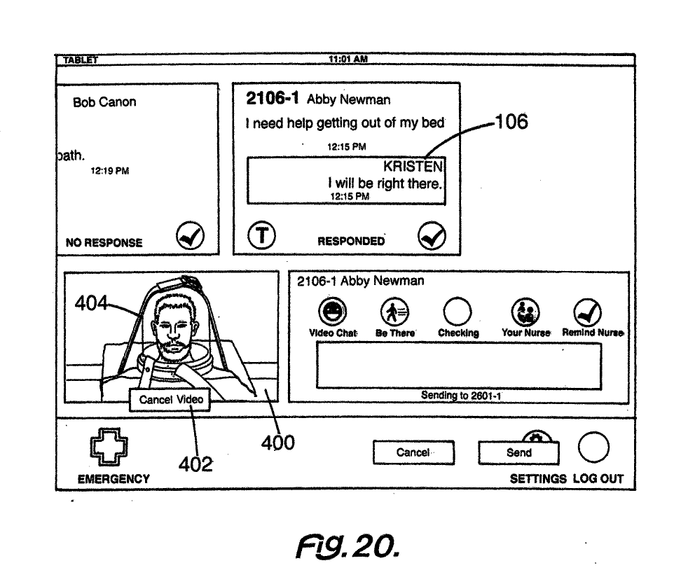

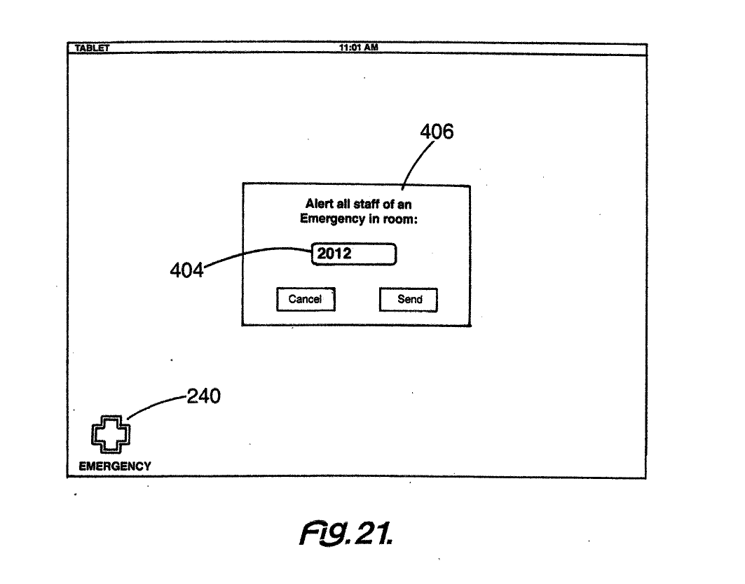

FIG. 20 depicts communication system 100 uses video messaging 400 to provide a televised patient 402 as well as audio contact with patient 402. Furthermore, nurse 106 is permitted to respond quickly to the request.

Tapping on a patient computer page 462 (FIG. 18) will show the nurse 106 the history of the conversation as well as give the nurse 106 the ability to write to the patient 102, use a shortcut button, video chat with the patient or send a reminder to the nurse 106. At the bottom of patient computer page 462, there is a responded button 244 or un-responded button 246 to send an appropriate message. If the nurse 106 responds to that patient 102, then patient 102 can be responsible for hitting the responded button 244 or un-responded button 246 to let everyone know it has been handled. This message will be automatically updated accordingly when a nurse 106 hits their checkmark for that patient 102.

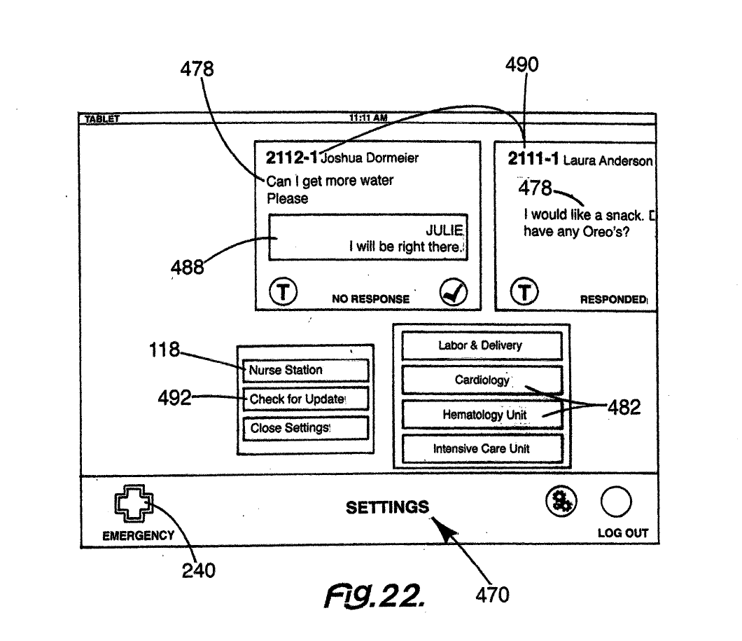

FIG. 21 depicts communication system 100 of this invention using emergency button 240 to alert all available staff 404 for action at the desired location or room number 406. The emergency button 240 will notify all the Nursing staff that there is an emergency in a particular room.

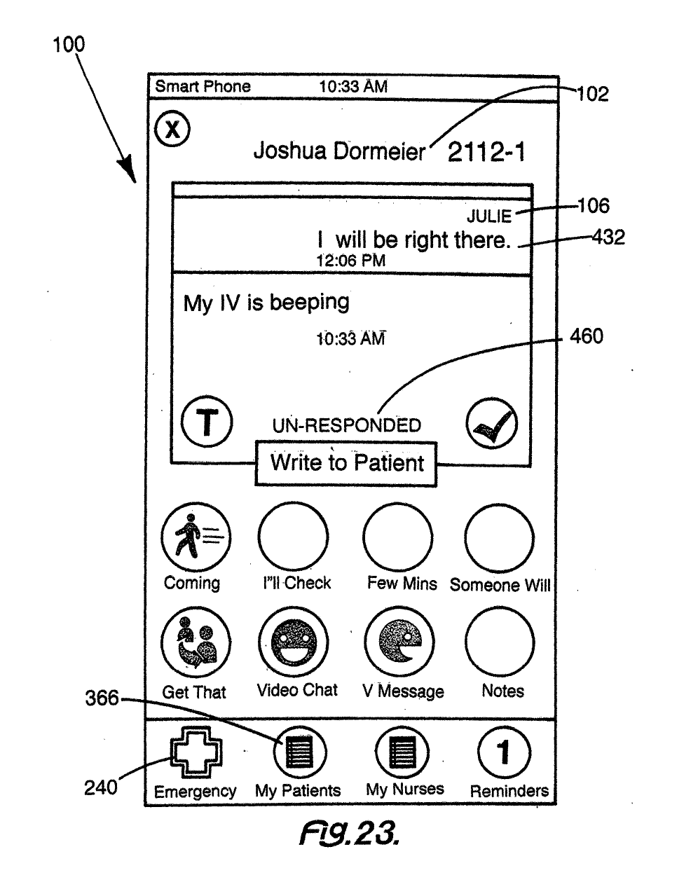

FIG. 22 depicts communication system 100 of this invention interacting with the station for nurses 118 while using the settings function 470 for the appropriate medical parameters 482, such as hematology or others on the particular unit 482 as selected. The update function 492 renders this action particularly efficient as to patient contact 488 and patient location 478, as well as updates on condition. The settings function 470 will allow the user to set which units are to be handled.

FIG. 23 depicts communication system 100 of this invention showing written communication with a nurse written message 432, to patient 102 from the nurse 106 of FIG. 3. Nurse 106 can access a patients list with my patients 366 and check unresponded 460. With the other communication means also available, nurse 106 can provide even more effective treatment for a patient 102. Combined with FIG. 10, FIG. 23 provides written communication between patient 102 and nurse 106 to flow in either direction.

The my patients page 366 has a list of all the rooms that the nurse 106 is covering in FIG. 24. This gives the nurse 106 a quick and easy way to communicate with the patient 102 as well as review the history. Each message 382, whether it be from a shortcut button, a custom button, video chat or video message, will have a time stamp 368 on it showing when it was sent. The checkmark button 386 permits nurse 106 (FIG. 3) to indicate when the matter has been handled.

Thus, it may be seen that communication system 100 of this invention permits greatly facilitated communication between the patient 102 and any member of the hospital staff. In this fashion, care of a patient 102 can be more efficient. At the same time, the staff, including but not limited to nurse 106 or doctor 108 is more effective and better able to provide the required level of service for each patient.

This application; taken as a whole with the abstract, specification, claims, and drawings being combined; provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed and sought to be protected by Letters Patent of the United States is:

1. A communication system with connections permitting contact between a hospital patient and at least one staff member of a hospital comprising:
a) a patient communication device with the hospital patient being adapted to communicate with at least one hospital communication device as used by the at least one staff member;
b) the patient communication device providing multiple ways for the hospital with patient to communicate to the at least one staff member;
c) the patient communication device being adapted to convey to the at least one staff member precisely what is needed through the at least one hospital communication device; and
d) the patient communication device including at least two icons for the patient to use in order to seek desired assistance from the hospital staff.

2. The communication system of claim 1 further comprising:
a) the patient communication device using a video chat, an audio only chat, simple one touch buttons, a written message, a speak to text, a simple mode, an emergency button or a video messaging system;
b) the emergency button causing all nurses available to the patient to be notified;
c) all messages from patients and hospital staff nurses being displayed and interacted with at a floor station for nurses;
d) the communication system using a communication device to send or receive messages from at least one other communication device;
e) The communication device being mobile; and
f) the all messages being an exchange of information between a patient and a nurse or nurses, or a nurse to nurse communication, or a nurse to other hospital personnel.

3. The communication system of claim 2 further comprising:
a) the communication system being useful in hospitals for children;
b) the communication system being a fun, a personal, an efficient and an easy approach to patient care;
c) the patient communication device having cartoon characters thereon for a child; and
d) the communication system being adapted to activate a light of any color outside a room of the patient in order to give a visual indication to the nurses as to the request of the patient.

4. The communication system of claim 2 further comprising:
a) the communication system using a communication device;
b) the communication device being a laptop computer, a desktop computer, a tablet, a smart watch, or a smart phone;
c) the communication system being adapted to a protocol system in place in a hospital; and
d) the communication system fitting a protocol system in a hospital.

5. The communication system of claim 4 further comprising:
a) the communication system having a different set up system depending on the need of the patient, the floor the patient is on, or the preference of the patient;
b) the communication system having a peripheral system for the patient to send an emergency message when the patient is away from the communication device in the room of the patient or with the patient away from the room;
c) a patient device being a tablet, a smart phone or a smart watch; and
d) the nurse choosing or setting assigned patients while having communication available with the patient, another nurse or hospital staff.

6. The communication system of claim 5 further comprising:
a) the communication system creating a reminders page in which messages are rendered in order of time from both a patient and a nurse;
b) the reminders page permitting the nurse to create a personal system of reminders;
c) the communication system thereby creating a display of patient requests, nurse to patient communications, patient to nurse communications, or nurse to nurse communications;
d) the communication system creating a way for a nurse to write notes or vital sign notes about each patient on at least one nurse communication device, or on a chart for the patient;
e) the communication system having an unresponded or unanswered setting to assure that a patient request receives a response in a timely manner; and
f) the communication system having a check-off when a request has been completed.

7. The communication system of claim 6 further comprising:
a) the communication system having a tracking application to track a location of the nurse or the patient;
b) the communication system having an exercise application for instructing the patient on an exercise procedure;
c) the communication system providing a map of the floor that easily tracks the last known location of the nurse or the patient; and
d) the patient device for the communication system being adapted to accompany the patient.

8. The communication system of claim 7 further comprising:
a) the communication system providing for the patient to order food;
b) the communication system having a proper diet for each patient; and
c) a settings page being available for a communication device in the communication system whether the communication device is used by a patient, a nurse, a doctor, other staff or the station for nurses to facilitate communication between the patient and the staff.

9. The communication system of claim 8 further comprising:
a) the communication system providing for the nurse to communicate with another nurse and the patients use multiple ways of communication;
b) the nurse providing room assignments with a settings page;
c) the settings page providing room assignments, floor or unit settings, a nurse assistant, a room assignment, a user log in, a name list or a required update;
d) the patient, the nurse or the staff having a log of the communications made;
e) the communication system providing a log in system for connecting a communication device to the communication system;
f) a patient being able to send multiple requests or messages; even if a first request or message has yet to receive a response; and
g) the multiple requests or messages being sent to a second nurse to promote a response.

10. The communication system of claim 9 further comprising:
a) the communication system having device system with members as a patient device, a staff device, a kitchen device, a doctor device, and a nurse device;
b) the device system providing two-way communication between each pair, while the same time providing access to at least one other device as desired; and
c) the device system including a smart phone, a tablet, a laptop, or a desk top computer.

11. The communication system of claim 10 further comprising:
a) the communication system providing that the patient be a child;
b) the child having access to a tablet;
c) the tablet being mounted at a first end of a flexible arm;
d) a second end of the flexible arm being secured to a surface; and
e) the flexible arm permitting the tablet to be accessible to the child.

12. The communication system of claim 11 further comprising:
a) the tablet being easily used by the child;
b) the tablet being removable from the flexible arm and taken with the patient as desired;
c) the tablet having a child screen;
d) the child screen depicting cartoon like characters and at least one icon; and
e) the at least one icon assisting the child in the use of the tablet.

13. The communication system of claim 10 further comprising:
a) the communication system requiring log in credentials for a nurse, a patient, or other staff to access a required device in the communication system;
b) the nurse being able to form nurse settings to choose, a shift coworker, a work unit, each assigned room and each assigned patient; and
c) the nurse setting determining where messages from the patient will be sent.

14. The communication system of claim 13 further comprising:
a) a function screen on the tablet by an adult or a child;
b) a function icon assembly permitting an appropriate adjustment of the function screen; and
c) the function screen permitting icon selection, a screen adjustment, a diet selections, a mode selections and a set up selection.

15. The communication system of claim 14 further comprising:
a) a write to your nurse function activates a keyboard to send a message to the nurse;
b) a conversation function permitting a patient to speak with the nurse;
c) a video messaging function permitting a patient to chat with and be seen by the nurse about various functions;
d) a patient written message function permitting a patient to write to the nurse by typing or speak to send a text;
e) a language setting mode permitting the patient to select an acceptable language for receiving and sending information;
f) a reminders page permitting the nurse to check reminders for work; and
g) the reminders being color coded for easy viewing.

16. The communications system of claim 15 further comprising:
a) the patient device having an emergency button to alert all of the nursing staff on a particular hospital unit;
b) the station for nurses including a full size tablet;
c) the full size tablet being releasably mounted on a flexible arm;
d) the full size tablet being portable and easily carried by the nurse when desired;
e) the full size tablet having a keyboard for easy typing by the nurse;
f) the communication system providing an overview of all activity in the nursing unit at the station for nurses; and
g) the communication system providing the nurse device with an unresponded screen to determine which patient is still waiting.

17. A method of providing a communication system with connections permitting contact between a hospital patient and at least one staff member of a hospital comprising:
a) providing a patient communication device for use by a hospital patient to communicate with at least one hospital communication device as used by the at least one staff member, wherein the patient communication device provides multiple ways for the hospital with patient to communicate to the at least one staff member;
b) conveying a message from the patient communication device by the patient to the at least one staff member precisely what is needed through the at least one hospital communication device;
c) providing the patient communication device with at least two icons for the patient to use in order to seek desired assistance from the hospital staff;
d) providing the patient communication device with a video chat, an audio only chat, simple one touch buttons, a written message, a speak to text, a simple mode, an emergency button or a video messaging system to communicate with at least one hospital communication device;
e) using the emergency button to alert causing all nurses available to the patient;
f) displaying all messages from patients and hospital staff nurses at a floor station for nurses;
g) sending or receiving messages from a communication device to at least one other communication device;
h) rendering the communication device mobile; and
i) exchanging information between a patient and a nurse or nurses, or a nurse to nurse communication, or a nurse to other hospital personnel.

18. The method of claim 17 further comprising:
a) adapting the communication system for use by children in hospitals for children;
b) having cartoon characters on the patient communication device thereon for a child;
c) activating a light of a desired the communication system being adapted to activate a light of any color outside a room of the patient in order to give a visual indication to the nurses as to the request of the patient;
d) the communication system using a communication device;
e) the communication device being a laptop computer, a desktop computer, a tablet, a smart watch, or a smart phone;
f) adapting the communication system to a protocol system in place in a hospital; and
g) fitting the communication to a protocol system in a hospital.

19. The method of claim 17 further comprising:
a) providing with having a different set up system depending on the need of the patient, the floor the patient is on, or the preference of the patient;
b) providing the communication system with a peripheral system for the patient to send an emergency message when the patient is away from the communication device in the room of the patient or with the patient away from the room;
c) having the patient device being a tablet, a smart phone or a smart watch;
d) maintaining communication with the patient, another nurse or hospital staff while the nurse is choosing or setting assigned patients;
e) creating a reminders page for the communication system in which messages are rendered in order of time from both a patient and a nurse;
f) creating a personal system of reminders for the nurse;
g) creating from the communication system a display of patient requests, nurse to patient communications, patient to nurse communications, nurse to nurse communications, or hospital staff to hospital staff or a patient;
h) providing notes for the nurse with the communication system, thereby creating a way for a nurse to write notes or vital sign notes about each patient on at least one nurse communication device, or on a chart for the patient;
i) providing an unresponded or unanswered setting for the communication system to assure that a patient request receives a response in a timely manner;
j) providing the communication system with a check-off when a request has been completed;
k) providing a tracking application to track a location of the nurse or the patient;
l) the communication system having an exercise application for instructing the patient on an exercise procedure;
m) providing a map of the floor for the communication system that easily tracks the last known location of the nurse or the patient; and
n) adapting the patient device for the communication system to accompany the patient;
o) providing for the nurse to communicate with another nurse or the patients to use multiple ways of communication;
p) providing room assignments for the nurse with a settings page;
q) providing the settings page with room assignments, floor or unit settings, a nurse assistant, a room assignment, a user log in, a name list or a required update;
r) providing the patient, the nurse or the staff with a log of the communications made; and
s) providing a log in system for connecting a communication device to the communication system.

20. The method of claim 19 further comprising:
a) a patient being able to send multiple requests or messages; even if a first request or message has yet to receive a response;
b) the multiple requests or messages being sent to a second nurse to promote a response;
j) the communication system having device system with members as a patient device, a staff device, a kitchen device, a doctor device, and a nurse device;
k) the device system providing two-way communication between each pair, while the same time providing access to at least one other device as desired;
l) the device system including a smart phone, a tablet, a laptop, or a desk top computer;
m) the communication system requiring log in credentials for a nurse, a patient, or other staff to access a required device in the communication system;
n) the nurse being able to form nurse settings to choose, a shift coworker, a work unit, each assigned room and each assigned patient;
o) the nurse setting determining where messages from the patient will be sent;
p) a function screen on the tablet by an adult or a child;
q) a function icon assembly permitting an appropriate adjustment of the function screen;
r) the function screen permitting icon selection, a screen adjustment, a diet selections, a mode selections and a set up selection;
s) a write to your nurse function activates a keyboard to send a message to the nurse;
t) a conversation function permitting a patient to speak with the nurse;
u) a video messaging function permitting a patient to chat with and be seen by the nurse about various functions;
v) a patient written message function permitting a patient to write to the nurse by typing or speak to send a text;
w) a language setting mode permitting the patient to select an acceptable language for receiving and sending information;
x) a reminders page permitting the nurse to check reminders for work;
y) the reminders being color coded for easy viewing;
z) the communication system providing an overview of all activity in the nursing unit at the station for nurses; and
aa) the communication system providing the nurse device with an unresponded screen to determine which patient is still waiting.
